(19) United States
(12) Patent Application Publication
(10) Pub. No.: US 2005/0040563 A1
(43) Pub. Date: Feb. 24, 2005

(54) Method for producing plastic hollow bodies using a rotational method

(76) Inventors: Eberhard Lang, Heilbronn (DE); Maik Ziegler, Grafenhain (DE); Jurgen Bruning, Werther (DE); Peter Nystrom, Habo (SE)

Correspondence Address: Norman P. Soloway;Hayes Soloway, 130 W. Cushing Street, Tucson, AZ, 85701, US

(21) Appl. No.: 10/496,039

(22) PCT Filed: Nov. 28, 2002
(86) PCT No.: PCT/EP02/13454

(30) Foreign Application Priority Data
Nov. 28, 2001 (DE) 101-58-152.1

(51) Int. Cl. B29C 44/00

(52) U.S. Cl. 264/489; 264/45.7

(57) ABSTRACT

The invention relates to a method for producing plastic hollow bodies which are filled, at least partially, with foam particles. The plastic hollow body is produced by rotational moulding and is filled, at least partially, in the rotational mould with foam particles. Foam particles which are made of the same type of a polyolefinic plastic material, from which the wall of the hollow body is also made, are used in order to simplify the recycling.

The invention relates to a method for producing plastic hollow bodies in the rotational process (rotational moulding) which are filled up, at least partially, with foam particles.

It is known to produce plastic hollow bodies by rotational moulding. Here, powder or granulate made of thermoplastic material is introduced in a heatable tool and, by rotation of the tool around one or several axes, diffused and melted on in a uniform way to the tool wall which encloses the form cavity or the “form nest”. In this way, it is possible to produce hollow bodies, such as barrels or canisters for example, as well as three-dimensionally formed decorative layers, preferably on the basis of polyvinyl chloride (PVC), for example for dash-boards or other parts of inner claddings of motor vehicles.

Another known method for producing hollow bodies is the blow-moulding process in which a premould or a profile extrudate is blown up inside a form cavity by means of a lance.

DE 199 30 903 A1 describes the filling of a blow-moulded hollow body with pre-expanded foam particles (beads) made of thermoplastic material such as for example polyurethane or polypropylene. The beads are blown in the hollow body in a condensed state, relaxed and meet there a volume increase, without however being welded or connected together.

A combination of a blow-moulded envelope with a foam filling is described in EP 0 583 542 A1, wherein first, a hollow body is produced by widening a premould which is filled with pre-expanded foam particles made of thermoplastic material such as polyethylene or polypropylene in a further processing step. Afterwards, the beads are expanded and welded together by means of superheated steam.

The filling up of the volume combined with rotational-moulded components is described in EP 0 774 819 A2, a filling up of the volume between two plastic housings which serve to the placement of cables or electrical constituents being achieved by subsequent insertion of a foamed material or reactive foaming of a polymer.

Frequently, composite structures also consist of particle foam materials combined with decorative and reinforcing layers in which foam particles are welded with superheated steam in the moulded part process, such as it is disclosed for example in DE 100 03 595 A1.

Furthermore, components are known in which cavities are filled up with polyurethane foams (PUR-E) or polystyrene foams (EPS). Here, sport boats, kayaks, buoys and fenders filled up with foam are cited as examples.

Because of the advanced process engineering, blow-moulded or rotational-moulded hollow bodies are cost effective mass-produced components which however show many mechanical and acoustic disadvantages. Apart a restricted bending strength, the pressure loading capacity particularly is also restricted. A sufficient bending strength is ensured only when a sandwich structure, namely by a pressure resistant core of foam, is provided. The absorption of impact strength is also restricted because of a lack of constituents which can absorb energy. This is why for example bumper are provided with a core of foam. Acoustically, an unfilled hollow body always acts as sound generator or sound amplifier particularly by stimulation of the solid-borne sound. Only rotational-moulded toys such as buggies which generate in use a considerable sound pressure by mechanical stimulation of the mostly non damped wheels are cited here as examples.

The blow-moulding process requires a geometrically simple structure of the component to be produced while the rotational-moulding process also permits the production of complex geometries. The wall thickness of blow-moulded bodies also varies considerably because of the different degrees of stretching. In the blow-moulding it is also necessary to make higher demands on the polymer concerning the tension of the melt than in the rotational-moulding process. The fabrication of hollow bodies produced in the blow-moulding process and filled with foam is coupled to a considerable technical expenditure. The subsequent insertion of foam particles, the filling of hollow bodies with foam and the design of composite structures are respectively coupled with several work cycles. Additionally, there is a considerable expenditure for the handling of the finished moulded parts because of the danger of damaging the parts with thin walls or of deforming all components. Up to now, it is difficult, in terms of process engineering, to realize a welding of the foam particles in the blow-moulded component. The use of high frequency engineering (microwaves) frequently leads to the creation of overheated regions (hotspots).

Bodies filled with polystyrene foam require mostly two separate processing steps, namely the steps of the foam moulding and the rotational moulding. The main disadvantage concerning polystyrene foams as well as concerning polyurethane foam fillings is the restricted capability of the moulded parts to be recycled because the outer skin in the form of the wall of the hollow body and the foam filling are made of different plastic materials, and in this way are not single-sorted.

The object of the invention is to provide a method for producing a single-sorted plastic hollow body with improved mechanical and acoustic properties.

According to the invention, this object is achieved by the filling of a rotational-moulded hollow body in the rotational mould with foam particles of the same material family, foam beads on the basis of polypropylene (EPP) or polyethylene (EPE) being preferably used here.

Therefore, the object of the invention is a method for producing a hollow body filled with foam particles, in which the wall of the hollow body is produced by rotational moulding and the hollow body is filled up, at least partially, with foam particles and the foam particles as well as the wall of the hollow body are made of the same type of polyolefinic plastic material.

The term “made of the same polyolefinic plastic material” does not mean that the foam particles and the wall of the hollow body have necessarily to be made exactly of the same polymer, though it is naturally possible. It is rather meant that a product is produced which is designed as “single-sorted” in the recycling technique, in this way a product which for example is made only of polypropylene or only of polyethylene, different types of polypropylene, for example with different chain lengths, different melting or softening points and other differences concerning their chemical and physical properties however being able to be used, but never two different types of polyolefins such as for example polypropylene for the wall of the hollow body and polyethylene for the foam particles.

Concerning the invention, it is also possible of course to use copolymerisats of different olefin monomers or such with elastomer parts (polyolefin elastomers), but the same type of copolymerisats respectively for the foam particles as well as for the wall of the hollow body also having to be used then in order to produce a single-sorted product.

Advantageous embodiments of the method according to the invention are characterized in that expanded polypropylene particles (EPP), expanded polyethylene particles (EPE) or particles of a thermoplastic polyolefin (TPO) or particles which are produced of cured or uncured polyethylene foam films (PEX) or polyethylene foam blocks by means of a comminution process are used as foam particles as well as in that the wall of the hollow body is made of polyethylene or polypropylene or of a thermoplastic polyolefin (TPO) based thereon, for example a copolymer or a thermoplastic elastomer.

Preferably, the wall of the hollow body is realized in a solid way or in the form of a slush skin.

In another preferred embodiment of the method according to the invention, first a core is introduced in the form cavity of a tool and afterwards the cavity between tool wall and core is filled up with foam. Here, it is possible to use a hollow body or a solid body as core.

In another preferred embodiment, the cavity between tool wall and core is filled up with foam and the cavity of the core is put under hydrostatic pressure and/or heated during the filling.

Preferably, the plastic material from which the tool wall is made contains a blowing agent which is activated during or after the rotational moulding.

Preferably, TPO powder or TPO granulates or the foam particles themselves are used to form the wall of the hollow body.

The addition of the foam particles occurs during the rotational moulding and in this way during the forming of the wall of the hollow body or immediately afterwards.

Preferably, the foam particles are melted on to the wall of the hollow body.

In another preferred embodiment, only a part of the foam particles are introduced in the tool during the rotational moulding.

It is possible to introduce the foam particles in the tool after the wall of the hollow body has been formed and the latter being still plastic, at least partially. But it is also possible to introduce them in the tool after the wall of the hollow body has been formed, when the wall is already cooled down and solidified.

In another preferred embodiment of the method according to the invention, the foam particles are introduced in the form cavity of the tool under hydrostatic counter-pressure and a filling up of the volume as well as a wedging of the foam particles occurs by a subsequent decompression. It is also possible to introduce the foam particles in the form cavity of the tool under mechanical pressure. After a subsequent pressure reduction or decompression a filling up of the volume and a wedging of the foam particles occur again.

Preferably, the foam particles are introduced in the form cavity of the tool in a state loaded with pressure in which the inner pressure of the particles is larger than the surrounding atmospheric pressure.

Polyolefinic plastic materials of the same type are preferably used for the wall of the hollow body and for the foam particles. They can be different but have similar melting or softening points.

Preferably, the foam particles are welded by means of the steam moulding process, in this way by means of superheated steam which penetrates the particles, the superheated steam being introduced in the rotational mould and being passed through the wall of the hollow body. For this, such beads are advantageously used which are made of coextruded plastic materials of the same type but which have been produced with a low-melting outer skin. It is possible to produce the low-melting outer skin of the beads by means of a barrel processing of a low-melting plastic material to the foam particles before their insertion in the rotational mould. Finally, the foam particles can be welded afterwards by means of microwave-heating or connected by means of a bonding agent (adhesive) which is capable of being pressure-activated.

The shaping of the outer skin of the hollow body, namely of the wall of the hollow body, is first realized by producing a hollow body in the rotational process by addition of a polymer powder or by the use of the polymer in the form of foam particles. After the preforming of the outer skin further foam particles are blown in during the process, the latter being promoted against an inner pressure in the tool of 1 to 5 bar for example in order to obtain a compression of the foam particles. The addition of the beads can also be realized under mechanical pressure, preferably by a revolver system. If necessary, only a partial region or only regions directly adjacent to the outer skin are provided with foam particles. At the wall of the hollow body a fusion of the foam particles with the outer skin is preferably obtained by an adapted temperature control.

The variant of the method according to the invention in which a low-melting particle outer skin or a bonding agent equipment ensures the welding or the sticking of the foam particles to each other and/or to the wall of the hollow body represents a preferred embodiment.

The pressure compensation after the filling operation results in an expansion of the condensed foam particles and in this way in a complete filling up of the volume and a wedging of the foam particles, whereby a fixation of the foam particles and in this way a form stability of the form body are ensured. Because of this, a subsequent welding of the foam particles to each other is not absolutely necessary. The use of the foam particles permits so with a low expenditure the production of components having a high dimension stability and a considerably improved capacity to absorb energy. The weight increase of the components can be compensated because of the higher stability due to the reduction of the wall thicknesses. The foam filling also generates an important noise insulation of the cavity volume of the moulded parts which frequently acts as sounding body.

Finally, the volume of the foam filling can be reduced by the use of a core which can also be a hollow body which itself can have been preferably produced by means of the method by rotational moulding described here.

In the following, the invention is described with more details and with reference to the drawings:

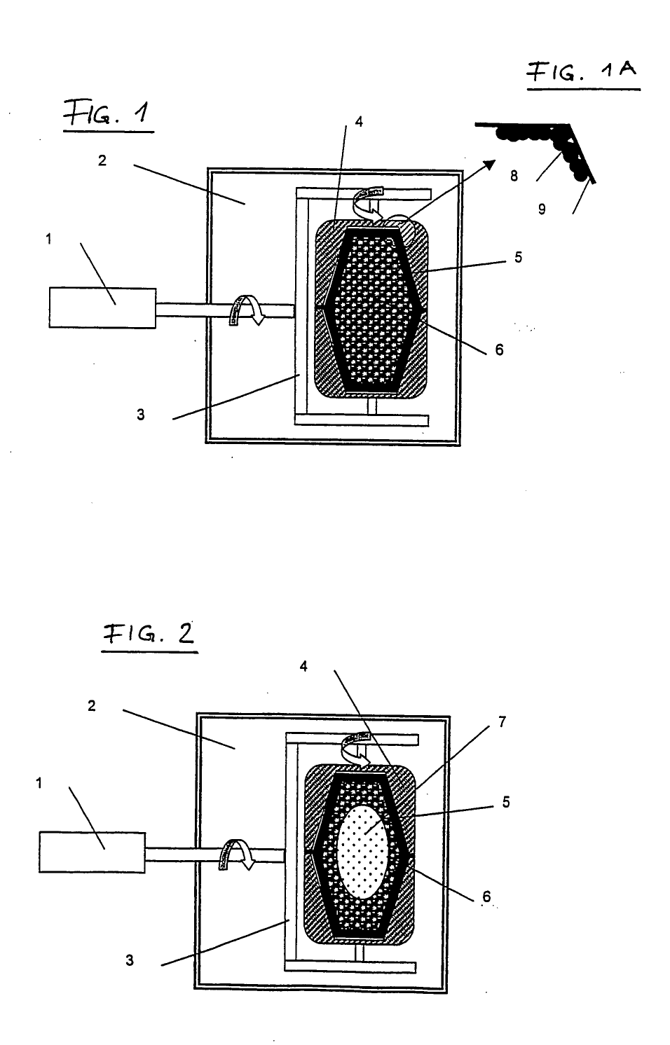

FIG. 1 is a schematic sectional view of a rotational form tool for the production of a hollow body filled with foam particles;

FIG. 1a is an extended section of a part of the wall of the hollow body shown in FIG. 1;

FIG. 2 is a schematic sectional view of a rotational mould for the production of a hollow body filled with foam particles and a core;

A two-part form tool 4 (FIG. 1) is clamped by a toolholder 3 which can be driven by a drive 1 and is positioned such that it can rotate around two axes which are perpendicular to each other. The direction of rotation is indicated by arrows. Toolholder 3 and tool 4 are placed inside an oven 2 such that the tool can be heated or tempered in the desired way. A hollow body 5 which is filled up with a foam particle filling 6 is located in the form cavity of the tool 4.

The hollow body 5 has been produced by placing powder, granulate or foam particles of a thermoplastic polyolefin in the form cavity of the tool 4 and by melting it on there by simultaneous rotation of the tool. During the rotation and in this way during the forming of the wall 9 of the hollow body (FIG. 1a) polyolefin foam particles 8, preferably EPP or EPE beads having a diameter of about 2 to 15 mm, are introduced inside the form cavity. The addition of the foam particles can occur, at least partially, during the rotational process, in order to obtain a partial fusion of the foam particles 8 with the wall 9 of the hollow body (FIG. 1a).

The foam particles 8 as well as the wall 9 of the hollow body consist of the same type of a polyolefinic plastic material, the materials used having at least a similar melting point in order to obtain a melting or sticking of the foam particles 8 to the inner wall 9 of the hollow body.

It is also possible to introduce the foam particles 8 after the rotational process such that a partial melting with the wall 9 of the hollow body which is still partially plastic occurs.

In another variant of the realization of the method according to the invention, the foam particles 8 can be added step by step in several partial quantities. One part can be added already during the rotational process while another part is introduced in the hollow body 5, which is in the tool 4, for the complete filling up of the volume after the rotational process, during the cooling phase in order to create the foam particle filling 6.

In another variant, it is possible to use exclusively foam particles 8 for the production of the hollow body 5, the foam particles 8 being used for the forming of the wall 9 of the hollow body as well as for the forming of the foam particle filling 6.

The supply of the polymer which forms the hollow body as well as of the foam particles can occur via external feeding pipes, conduits, hoses etc. which are not shown in the drawings, or by a filling system which is integrated in the toolholder 3.

In another embodiment (FIG. 2), a core 7 in the form of a solid body or in the form of a further hollow body which remains in the hollow body 5 is integrated in the form cavity of the tool 4 in order to limit the space which has to be filled up with foam particles 8. It is possible to introduce the core 7 before, during or after the realization of the rotational process, but definitively before the addition of the foam particles 8 which fill up the remaining volume.

The supply of the foam particles occurs against an inner pressure of the tool of preferably 1 to 5 bar with a pressure differential of preferably 0.1 to 3.0 bar, on the one hand to condense the foam particles and on the other hand to generate a flow and in this way to obtain a filling of the tool. If the filling occurs step by step, it is possible, in the first step for the forming of the hollow body and of the foam regions at the wall of the hollow body, to fill either with an increased pressure and with differential pressure or to fill the tool nearly pressureless, and, in the second step, to increase the pressure differential.

An expansion of the condensed foam particles is obtained by decompression after the filling, which leads to the wedging of the foam particles and to a nearly complete filling up of the volume of the hollow body. Depending on the selection of the filling pressure and of the counter-pressure during the filling it is possible to influence the density of the foam particle filling 6. If high differential pressures are selected, this can lead, after the filling and the decompression, to the fact that by the recovery of shape and the filling up of the volume of the foam beads a certain overpressure remains. This have a positive effect because it gives the foam structure an inner stability. A variation of the density and of the hardness of the foam filling inside the hollow body can be obtained by filling step by step and, optionally, by division of the hollow body in individual regions or chambers. Further, lockable openings can be provided at the hollow body such that the foam filling can be modified afterwards.

By penetrating the foam particle filling 6 with superheated steam or by microwave-irradiation the foam particles 8 can be welded to each other and/or to the wall 9 of the hollow body.

1-24. (canceled)

25. A method for producing a hollow body filled with foam particles of a polyolefinic plastic material, wherein the wall of the hollow body is produced by rotational moulding using such foam particles and the hollow body is filled up, at least partially, with the same foam particles.

26. The method according to claim 25, wherein expanded polypropylene particles (EPP) or expanded polyethylene particles (EPE) or particles of a thermoplastic polyolefin (TPO) or particles which are produced of cured or uncured polyethylene foam films (PEX) or polyethylene foam blocks by means of a comminution process are used as said foam particles.

27. The method according to claim 25, wherein said wall of the hollow body is made of polyethylene (PE) or polypropylene (PP) or a thermoplastic polyolefin (TPO) based thereon.

28. The method according to claim 25, wherein first a core is introduced in the form cavity of the tool and afterwards the cavity between tool wall and core is filled up with

29. The method according to claim 28, wherein a hollow body or a solid body is used as said core.

30. The method according to claim 28, wherein the cavity between said tool wall and said core is filled up with foam and the cavity of the core is put under hydrostatic pressure and/or heated during the filling.

31. The method according to claim 25, wherein only a part of said foam particles is introduced in the tool during the rotational moulding.

32. The method according to claim 25, wherein foam particles are introduced in the tool after said wall of the hollow body has been formed and the wall being still plastic, at least partially.

33. The method according to claim 25, wherein foam particles are introduced in the tool after said wall of the hollow body has been formed and the wall being already solidified.

34. The method according to claim 25, wherein said foam particles are introduced in the form cavity of the tool under hydrostatic counter-pressure and that a filling up of the volume and a wedging of said foam particles occurs by a subsequent decompression.

35. The method according to claim 25, wherein said foam particles are introduced in the form cavity of the tool under mechanical pressure and that a filling up of the volume and a wedging of said foam particles occurs by a subsequent decompression.

36. The method according to claim 25, wherein said foam particles are introduced in the form cavity of the tool in a state loaded with pressure.

37. The method according to claim 25, wherein said foam particles are welded by means of penetrating superheated steam which is introduced in the rotational mould and is passed through said wall of the hollow body.

38. The method according to claim 37, wherein beads coextruded with a low-melting outer skin are used as foam particles.

39. The method according to claim 38, wherein a low-melting plastic material is barrel-applied to the foam particles, in order to form the outer skin thereof, before their insertion in the rotational mould.

40. The method according to claim 25, wherein said foam particles are welded afterwards by means of microwave-heating.

41. The method according to claim 25, wherein said foam particles are connected by means of a bonding agent which is capable of being pressure-activated.
